(19) United States
(12) Patent Application Publication
(10) Pub. No.: US 2026/0051702 A1
(43) Pub. Date: Feb. 19, 2026

(54) CONNECTOR, HIGH-VOLTAGE POWER CONNECTOR AND CONNECTOR ASSEMBLY

(71) Applicant: Tyco Electronics (Shanghai) Co., Ltd., Shanghai (CN)

(72) Inventors: Ke Wang, Suzhou (CN); Xiao (Nichee) Zhou, Shanghai (CN)

(73) Assignee: Tyco Electronics (Shanghai) Co., Ltd., Shanghai (CN)

(21) Appl. No.: 19/300,845

(22) Filed: Aug. 15, 2025

(30) Foreign Application Priority Data
Aug. 16, 2024 (CN) 202411134529.2

(51) Int. Cl. H01R 13/631; H01R 13/53

(52) U.S. Cl. CPC H01R 13/6315; H01R 13/53

(57) ABSTRACT

A connector includes an insulating housing, a terminal disposed in the insulating housing, a mounting portion mounted to a fixing member, and a floating mechanism disposed between the insulating housing and the mounting portion. The floating mechanism enables the insulating housing to float in three directions perpendicular to each other relative to the mounting portion. The floating mechanism has a first spring and plurality of second springs. The first spring is compressed in an axial direction of the insulating housing between the insulating housing and the mounting portion. The first spring enables the insulating housing to float in the axial direction. The plurality of second springs are spaced apart in a circumferential direction of the insulating housing and stretched in a radial direction of the insulating housing between the insulating housing and the mounting portion. The plurality of second springs enable the insulating housing to float in the radial direction.

### CROSS-REFERENCE TO RELATED APPLICATION

This application claims the benefit of the filing date under 35 U.S.C. § 119(a)-(d) of Chinese Patent Application No. CN202411134529.2 filed on Aug. 16, 2024, the whole disclosure of which is incorporated herein by reference.

### FIELD OF THE INVENTION

The present invention relates to a connector and, more particularly, to a low-voltage signal connector for controlling power-on and power-off of a power terminal of a high-voltage power connector.

### BACKGROUND OF THE INVENTION

In the prior art, for safety reasons, it is desirable that a high-voltage power terminal is power-disconnected in the process of tightening or loosening the high-voltage power terminal of a high-voltage power connector. Thus, in the prior art, a low-voltage signal connector for controlling power-on and power-off of the high-voltage power terminal is generally integrated in the high-voltage power connector, and the low-voltage signal connector is generally referred to as a high voltage interlock connector. In the process of tightening or loosening the high-voltage power terminal, the low-voltage signal connector is electrically disconnected from a mating signal connector, resulting in power-off of the high-voltage power terminal. After the high-voltage power terminal is fastened to the mating power terminal, the low-voltage signal connector is electrically connected to the mating signal connector, resulting in power-on of the high-voltage power terminal.

In the prior art, the position of the low-voltage signal connector in the high-voltage power connector is fixed and cannot float relative to a housing of the high-voltage power connector; consequently, the low-voltage signal connector cannot absorb mounting and manufacturing errors, thereby causing great difficulty to the mating operation of the low-voltage signal connector.

### SUMMARY OF THE INVENTION

A connector includes an insulating housing, a terminal disposed in the insulating housing, a mounting portion mounted to a fixing member, and a floating mechanism disposed between the insulating housing and the mounting portion. The floating mechanism enables the insulating housing to float in three directions perpendicular to each other relative to the mounting portion. The floating mechanism has a first spring and plurality of second springs. The first spring is compressed in an axial direction of the insulating housing between the insulating housing and the mounting portion. The first spring enables the insulating housing to float in the axial direction. The plurality of second springs are spaced apart in a circumferential direction of the insulating housing and stretched in a radial direction of the insulating housing between the insulating housing and the mounting portion. The plurality of second springs enable the insulating housing to float in the radial direction.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a cross-sectional view of the connector of FIG. 1;

FIG. 3 is a bottom perspective view of the connector of FIG. 1, with a mounting portion not shown;

FIG. 4 is a bottom partial exploded view of the connector of FIG. 1, with a mounting portion not shown;

FIG. 5 is a top perspective view of a connector according to another exemplary embodiment; and

FIG. 6 is a bottom perspective view of the connector of FIG. 5.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

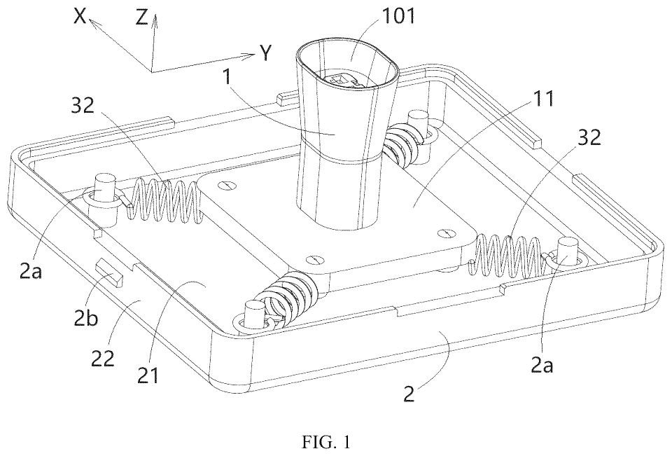

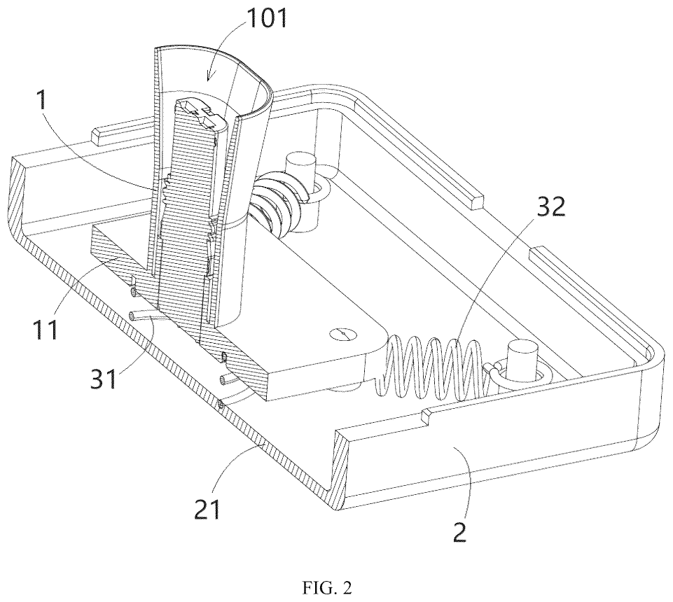

An exemplary embodiment of a connector will now be described with reference to FIGS. 1-4. As shown in FIGS. 1-2, the connector comprises an insulating housing 1, a terminal, a mounting portion 2, and a floating mechanism. The terminal is disposed in the insulating housing 1. The mounting portion 2 is configured to be mounted to a fixing member. The floating mechanism, as shown in FIGS. 1-2, is disposed between the insulating housing 1 and the mounting portion 2 to enable the insulating housing 1 to float in three directions X, Y, Z perpendicular to each other relative to the mounting portion 2.

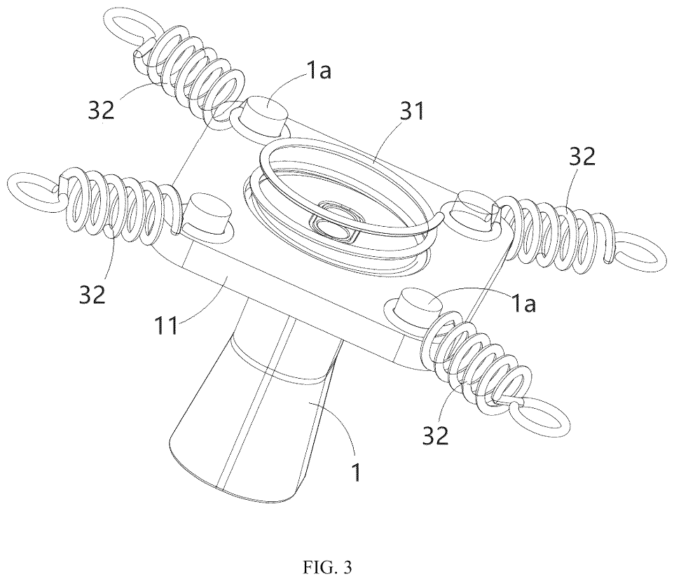

As shown in FIGS. 2-3, the floating mechanism comprises a first spring 31 and a plurality of second springs 32. As shown in FIG. 2, the first spring 31 is compressed in an axial direction of the insulating housing 1 between the insulating housing 1 and the mounting portion 2 to enable the insulating housing 1 to float in the axial direction thereof. The plurality of second springs 32 are spaced apart in a circumferential direction of the insulating housing 1 and are stretched in a radial direction of the insulating housing 1 between the insulating housing 1 and the mounting portion 2 to enable the insulating housing 1 to float in the radial direction thereof.

The terminal is adapted to mate with a mating terminal of a mating connector inserted in the axial direction of the insulating housing 1. The three directions X, Y, Z comprise a first direction Z parallel to the axial direction of the insulating housing 1, a second direction Y perpendicular to the axial direction of the insulating housing 1 and a third direction X perpendicular to the first direction Z and the second direction Y.

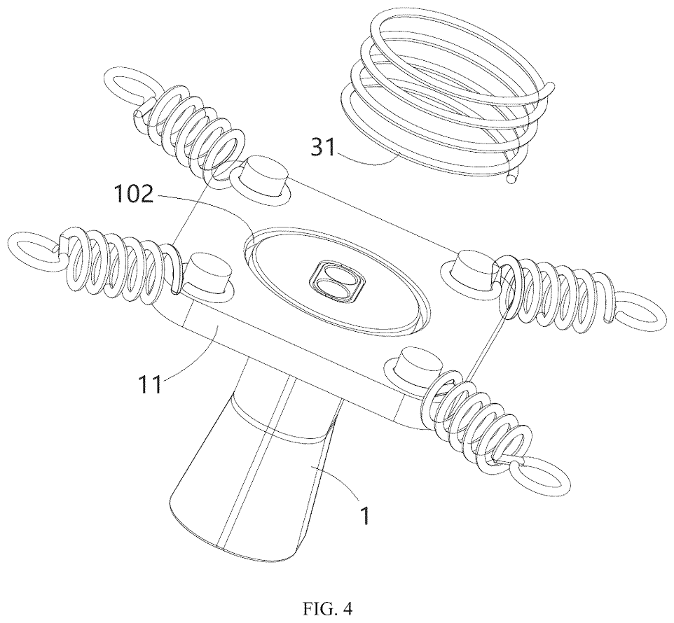

As shown in FIGS. 1-4, a flange portion 11 is formed on the insulating housing 1. The first spring 31 is axially compressed between the flange portion 11 and the mounting portion 2, and the second springs 32 are radially stretched between the flange portion 11 and the mounting portion 2. An annular positioning groove 102 is formed in the flange portion 11, as shown in FIG. 4, or the mounting portion 2. As shown in FIG. 2, one end of the first spring 31 is mounted and positioned in the positioning groove 102. However, the present invention is not limited to the illustrated embodiment; for example, an annular positioning groove 102 may be formed in each of the flange portion 11 and the mounting portion 2, and two ends of the first spring 31 are mounted and positioned in the two positioning grooves 102.

A plurality of first connecting posts 1a, as shown in FIG. 3, are formed on the flange portion 11, and a plurality of second connecting posts 2a, as shown in FIG. 1, are formed on the mounting portion 2. One end of each of the plurality of second springs 32 is connected to the respective one of the plurality of first connecting post 1a, and the other end of each of the plurality of second springs 32 is connected to the respective one of the plurality of second connecting post 2a.

As shown in FIG. 3, four first connecting posts 1a are formed on the flange portion 11, and the four first connecting posts 1a are located at four corners of the flange portion 11, respectively. As shown in FIG. 1, four second connecting posts 2a respectively corresponding to the four first connecting posts 1a are formed on the mounting portion 2. As shown in FIG. 3, the floating mechanism comprises four second springs 32, one end of each of the four second springs 32 is connected to the respective one of the four first connecting posts 1a, and the other end of each of the four second springs 32 is connected to the respective one of the four second connecting posts 2a.

As shown in FIG. 1, the mounting portion 2 is in the shape of a cover and comprises a cover plate 21 and a peripheral wall 22 surrounding the cover plate 21, and the second connecting posts 2a are formed on the cover plate 21. As shown in FIG. 2, the first spring 31 is axially compressed between the flange portion 11 and the cover plate 21.

As shown in FIG. 1, a protrusion 2b is formed on the peripheral wall 22 of the mounting portion 2. The protrusion 2b is adapted to engage with a snap-fit member on the fixing member to fix the mounting portion 2 to the fixing member.

The connector according to FIGS. 1-4 is a low-voltage signal connector for controlling power-on and power-off of a high-voltage power terminal of a high-voltage power connector. The high-voltage power terminal is powered on when the terminal of the connector is in electrical contact with the mating terminal of the mating connector. The high-voltage power terminal is powered off when the terminal of the connector is electrically disconnected from the mating terminal of the mating connector.

As shown in FIGS. 1-2, the insulating housing 1 has an insertion port 101 that allows the insertion of a mating insulating housing of the mating connector. The insertion port 101 of the insulating housing 1 is shaped like a trumpet that opens outward to guide the mating insulating housing to be centrally inserted into the insertion port 101 of the insulating housing 1. In other words, the insertion port 101 is trumpet shaped.

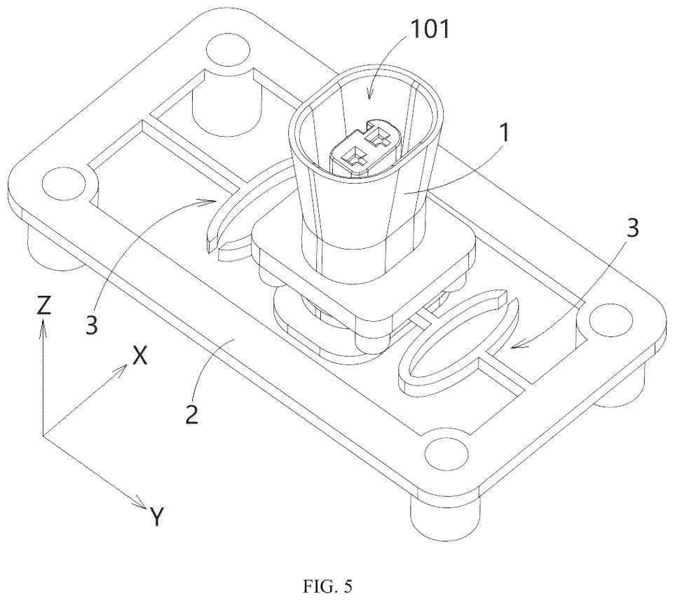

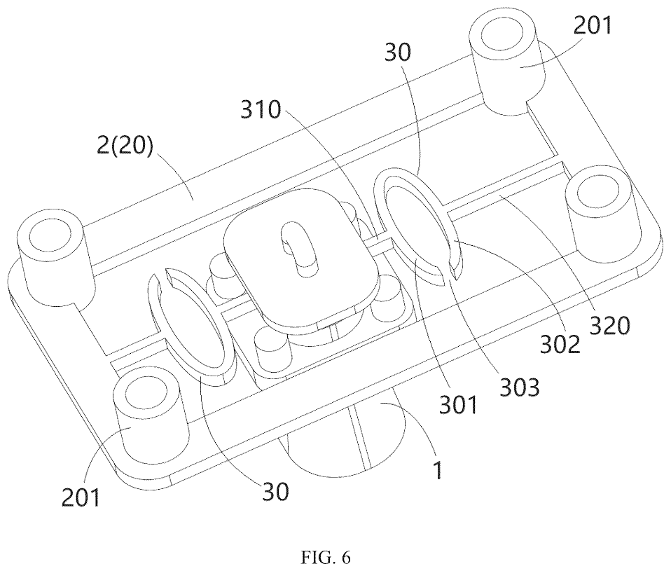

Another exemplary embodiment of a connector will now be described with reference to FIGS. 5-6. As shown in FIG. 5, the connector comprises an insulating housing 1, a terminal, a mounting portion 2 and a floating mechanism. The terminal is disposed in the insulating housing 1. The mounting portion 2 is configured to be mounted to a fixing member. The floating mechanism is disposed between the insulating housing 1 and the mounting portion 2 to enable the insulating housing 1 to float in three directions X, Y, Z perpendicular to each other relative to the mounting portion 2.

As shown in FIG. 5, the floating mechanism comprises a plurality of elastic connecting structures 3. The plurality of elastic connecting structures 3 are spaced apart in a circumferential direction of the insulating housing 1 and are connected between the insulating housing 1 and the mounting portion 2 in a radial direction of the insulating housing 1. The insulating housing 1, the mounting portion 2, and the plurality of elastic connecting structures 3 are formed as an integral part. For example, the integral part may be an integrated injection molded part.

As shown in FIG. 5, the mounting portion 2 comprises a frame 20. The insulating housing 1 is supported in the frame 20 of the mounting portion 2 in a suspended manner by the plurality of elastic connecting structures 3. A plurality of mounting sleeves 201, as shown in FIG. 6, are formed on the frame 20 of the mounting portion 2. The plurality of mounting sleeves 201 are adapted to be in interference fit with a plurality of mounting posts on the fixing member to fix the mounting portion 2 to the fixing member.

As shown in FIG. 5, the frame 20 is rectangular and has four corners. In other words, the frame 20 has a rectangular shape having four corners. Four mounting sleeves 201, as shown in FIG. 6, are formed on the frame 20, and the four mounting sleeves 201 are located at the four corners of the frame 20, respectively.

As shown in FIG. 6, the elastic connecting structure 3 comprises: an elastic ring 30, a first connecting arm 310, and a second connecting arm 320. The elastic ring 30 is in the form of a C shape with a gap 303 and comprises a first arc-shaped arm 301 and a second arc-shaped arm 302 opposite each other. The first connecting arm 310 is connected between the first arc-shaped arm 301 of the elastic ring 30 and the insulating housing 1. The second connecting arm 320 is connected between the second arc-shaped arm 302 of the elastic ring 30 and the mounting portion 2. The elastic ring 30 is elastically deformable in axial and radial directions of the insulating housing 1 to enable the insulating housing 1 to float relative to the mounting portion 2 in the axial and radial directions of the insulating housing 1.

The first connecting arm 310 and the second connecting arm 320 are elastically deformable in the axial and radial directions of the insulating housing 1 to increase the amount of floating of the insulating housing 1 in the axial and radial directions thereof. As shown in FIG. 6, the first connecting arm 310 and the second connecting arm 320 extend linearly in the radial direction of the insulating housing 1 and are aligned with each other in the radial direction of the insulating housing 1.

The terminal is adapted to mate with a mating terminal of a mating connector inserted in the axial direction of the insulating housing 1. The three directions X, Y, Z comprise a first direction Z parallel to the axial direction of the insulating housing 1, a second direction Y perpendicular to the axial direction of the insulating housing 1 and a third direction X perpendicular to the first direction Z and the second direction Y.

As shown in FIG. 5, the floating mechanism comprises two elastic connecting structures 3. The two elastic connecting structures 3 are opposite each other in the second direction Y. As shown in FIG. 6, the gaps 303 of the elastic rings 30 of the two elastic connecting structures 3 face in opposite directions.

In the aforementioned exemplary embodiments according to the present invention, the insulating housing 1 of the connector according to FIGS. 1-4 and 5-6 is capable of floating in three directions perpendicular to each other relative to the mounting portion 2, so that mounting and manufacturing errors can be absorbed effectively, enabling the connector according to FIGS. 1-4 and 5-6 to be mated with the mating connector easily.

An exemplary embodiment of a high-voltage power connector will now be described with reference to FIGS. 1-6. The high-voltage power connector comprises a housing, a high-voltage power terminal, and the connector according to FIG. 1-4 or 5-6. The high-voltage power terminal is disposed in the housing. The connector according to FIG. 1-4 or 5-6 is mounted into the housing for controlling power-on and power-off of the high-voltage power terminal. The high-voltage power terminal is powered on when the terminal of the connector according to FIG. 1-4 or 5-6 is in electrical contact with the mating terminal of the mating connector. The high-voltage power terminal is powered off when the terminal of the connector according to FIG. 1-4 or 5-6 is electrically disconnected from the mating terminal of the mating connector.

An exemplary embodiment of a connector assembly will now be described with reference to FIGS. 1-6. The connector assembly comprises the connector according to FIG. 1-4 or 5-6 and a mating connector mating with the connector according to FIG. 1-4 or 5-6.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
an insulating housing;
a terminal disposed in the insulating housing;
a mounting portion mounted to a fixing member; and
a floating mechanism disposed between the insulating housing and the mounting portion, the floating mechanism enables the insulating housing to float in three directions perpendicular to each other relative to the mounting portion, the floating mechanism has a first spring and plurality of second springs, the first spring is compressed in an axial direction of the insulating housing between the insulating housing and the mounting portion, the first spring enables the insulating housing to float in the axial direction, the plurality of second springs are spaced apart in a circumferential direction of the insulating housing and stretched in a radial direction of the insulating housing between the insulating housing and the mounting portion, the plurality of second springs enable the insulating housing to float in the radial direction.

2. The connector of claim 1, wherein the terminal mates with a mating terminal of a mating connector inserted in the axial direction, and the three directions include a first direction parallel to the axial direction, a second direction perpendicular to the axial direction, and a third direction perpendicular to the first direction and the second direction.

3. The connector of claim 1, wherein a flange portion is formed on the insulating housing, the first spring is axially compressed between the flange portion and the mounting portion, and the plurality of second springs are radially stretched between the flange portion and the mounting portion.

4. The connector of claim 3, wherein an annular positioning groove is formed in the flange portion or the mounting portion, and one end of the first spring is mounted and positioned in the positioning groove, or an annular positioning groove is formed in each of the flange portion and the mounting portion, and each end of two ends of the first spring are mounted and positioned in one of the positioning grooves formed in the flange portion and the mounting portion.

5. The connector of claim 3, wherein a plurality of first connecting posts are formed on the flange portion, and a plurality of second connecting posts are formed on the mounting portion, one end of each second spring is connected to one first connecting post, and an other end of each second spring is connected to one second connecting post.

6. The connector of claim 5, wherein the plurality of first connecting posts include four first connecting posts each formed on the flange portion, the four first connecting posts are each located at one of four corners of the flange portion, and the plurality of second connecting posts include four second connecting posts formed on the mounting portion and each corresponding to one of the four first connecting posts, the plurality of second springs include four second springs, one end of each of the four second springs is connected to one of the four first connecting posts, and an other end of each of the four second springs is connected to one of the four second connecting posts.

7. The connector of claim 5, wherein the mounting portion has a cover shape and includes a cover plate and a peripheral wall surrounding the cover plate, each second connecting post is formed on the cover plate, and the first spring is axially compressed between the flange portion and the cover plate.

8. The connector of claim 7, wherein a protrusion is formed on the peripheral wall, the protrusion engages a snap-fit member on the fixing member to fix the mounting portion to the fixing member.

9. A connector, comprising:
an insulating housing;
a terminal disposed in the insulating housing;
a mounting portion mounted to a fixing member; and
a floating mechanism disposed between the insulating housing and the mounting portion, the floating mechanism enables the insulating housing to float in three directions perpendicular to each other relative to the mounting portion, the floating mechanism has a plurality of elastic connecting structures spaced apart in a circumferential direction of the insulating housing and connected between the insulating housing and the mounting portion in a radial direction of the insulating housing, and the insulating housing, the mounting portion, and the plurality of elastic connecting structures are formed as an integral part.

10. The connector of claim 9, wherein the mounting portion has a frame, the insulating housing is supported in the frame in a suspended manner by the plurality of elastic connecting structures, a plurality of mounting sleeves are formed on the frame, and the plurality of mounting sleeves are interference fit with a plurality of mounting posts on the fixing member to fix the mounting portion to the fixing member.

11. The connector of claim 10, wherein the frame has a rectangular shape having four corners, four mounting sleeves formed on the frame are each located at one of the four corners of the frame.

12. The connector of claim 9, wherein each elastic connecting structure has an elastic ring having a C shape with a gap, each elastic ring includes a first arc-shaped arm and a second arc-shaped arm opposite each other, a first connecting arm connected between the first arc-shaped arm and the insulating housing, and a second connecting arm connected between the second arc-shaped arm and the mounting portion, the elastic ring is elastically deformable in an axial direction of the insulating housing and the radial direction, the elastic ring enables the insulating housing to float relative to the mounting portion in the axial direction and the radial direction.

13. The connector of claim 12, wherein the first connecting arm and the second connecting arm are elastically deformable in the axial direction and the radial direction to increase an amount of floating of the insulating housing in the axial direction and the radial direction.

14. The connector of claim 13, wherein the first connecting arm and the second connecting arm each extend linearly in the radial direction and are aligned with each other in the radial direction.

15. The connector of claim 12, wherein the terminal mates with a mating terminal of a mating connector inserted in the axial direction, the three directions include a first direction parallel to the axial direction, a second direction perpendicular to the axial direction, and a third direction perpendicular to the first direction and the second direction.

16. The connector of claim 15, wherein the plurality of elastic connecting structures include two elastic connecting structures, the two elastic connecting structures are opposite each other in the second direction, and the gap of each elastic ring of each of the two elastic connecting structures face in opposite directions.

17. The connector of claim 1, wherein the connector is a low-voltage signal connector for controlling power-on and power-off of a high-voltage power terminal of a high-voltage power connector, the high-voltage power terminal is powered on when the terminal of the connector is in electrical contact with a mating terminal of a mating connector, and the high-voltage power terminal is powered off when the terminal of the connector is electrically disconnected from the mating terminal of the mating connector.

18. The connector of claim 17, wherein the insulating housing has an insertion port, the insertion port is trumpet shaped and opens outward to guide a mating insulating housing of the mating connector to be centrally inserted into the insertion port.

19. A high-voltage power connector, comprising:
a housing;
a high-voltage power terminal disposed in the housing; and
a connector including an insulating housing, a terminal disposed in the insulating housing, a mounting portion mounted to a fixing member, and a floating mechanism disposed between the insulating housing and the mounting portion, the floating mechanism enables the insulating housing to float in three directions perpendicular to each other relative to the mounting portion, the floating mechanism has a first spring and plurality of second springs, the first spring is compressed in an axial direction of the insulating housing between the insulating housing and the mounting portion, the first spring enables the insulating housing to float in the axial direction, the plurality of second springs are spaced apart in a circumferential direction of the insulating housing and stretched in a radial direction of the insulating housing between the insulating housing and the mounting portion, the plurality of second springs enable the insulating housing to float in the radial direction, the connector is mounted into the housing and controls power-on and power-off of the high-voltage power terminal, the high-voltage power terminal is powered on when the terminal of the connector is in electrical contact with a mating terminal of a mating connector, and the high-voltage power terminal is powered off when the terminal of the connector is electrically disconnected from the mating terminal of the mating connector.
